(19) United States
(12) Patent Application Publication
(10) Pub. No.: US 2008/0223455 A1
(43) Pub. Date: Sep. 18, 2008

(54) Gas supply unit

(75) Inventors: Jota Fukuhara, Yokkaichi-shi (JP); Hotaka Ishizuka, Yokkaichi-shi (JP); Yoshio Sugimoto, Yokkaichi-shi (JP); Yasunori Nishimura, Kasugai-shi (JP); Kazutoshi Itoh, Kani-shi (JP); Akihito Sugino, Inuyama-shi (JP); Hiroshi Tomita, Kasugai-shi (JP)

Correspondence Address: OLIFF & BERRIDGE, PLC, P.O. BOX 320850, ALEXANDRIA, VA, 22320-4850, US

(73) Assignees: CKD CORPORATION, KOMAKI-SHI (JP); KABUSHIKI KAISHA TOSHIBA, TOKYO (JP)

(21) Appl. No.: 12/073,786

(22) Filed: Mar. 10, 2008

(30) Foreign Application Priority Data
Mar. 16, 2007 (JP) 2007-069194

(51) Int. Cl. F16K 31/00

(52) U.S. Cl. 137/488; 137/624.27

(57) ABSTRACT

To provide a gas supply unit capable of stabilizing a gas supply amount, the gas supply unit includes a mass flow controller, a first fluid control valve connected to the mass flow controller, a second fluid control valve connected in parallel to the first fluid control valve, and a third fluid control valve placed on a secondary side of the second fluid control valve. An opening degree of the third fluid control valve is adjusted based on a pressure difference between secondary pressure of the first fluid control valve and secondary pressure of the second fluid control valve.

### BACKGROUND OF THE INVENTION

1. Field of the Invention

The present invention relates to a gas supply unit for supplying process gas.

2. Description of Related Art

Of conventional semiconductor manufacturing devices, for example, a CVD (chemical vapor deposition) device for forming a thin film on the surface of a wafer is arranged to supply one or more kinds of process gases containing elements for a thin-film material, to the wafer. To produce a desired thin film on the wafer, for instance, a gas supply unit disclosed in JP2000-122725A is assembled in the CVD device and operated to continuously supply a constant amount of process gas to the wafer.

FIG. 17 is a circuit diagram of a conventional gas supply unit 100.

This gas supply unit 100 includes a supply line 4 in which a hand valve 11, a regulator 12, a pressure gauge 13, a mass flow controller (MFC) 14, and a first shut-off valve 15 are arranged. An upstream side of the supply line 4 is connected to a process gas supply source 2 and a downstream side of the same is connected to a process chamber 3. A discharge line 5 branches from the supply line 4 between the MFC 14 and the first shut-off valve 15. The discharge line 5 is provided with a second shut-off valve 17 and connected to a vacuum pump 6 that is also connected to the process chamber 3.

During process, in the above gas supply unit 100, the first shut-off valve 15 is opened and the second shut-off valve 17 is closed to supply process gas to the process chamber 3 at a flow rate controlled by the MFC 14. During non-process, on the other hand, the first shut-off valve 15 is closed and the second shut-off valve 17 is opened to allow the process gas to flow in the discharge line 5 while the process chamber 3 is evacuated to form a vacuum. In this way, the first shut-off valve 15 and the second shut-off valve 17 are alternately opened and closed.

### SUMMARY OF THE INVENTION

However, the conventional gas supply unit 100 would cause variation in cumulative flow rate even though the flow rate of process gas is controlled by the MFC 14. The reason of the variation in cumulative flow rate is considered as follows.

If secondary pressure (downstream pressure) P1 of the first shut-off valve 15 and secondary pressure (downstream pressure) P2 of the second shut-off valve 17 are equal at the time when the first shut-off valve 15 is changed from a closed state to an open state and simultaneously the second shut-off valve 17 is changed from an open state to a closed state, secondary pressure of the MFC 14 does not fluctuate. In this case, the process gas at a predetermined flow rate is allowed to pass though the first shut-off valve 15 and into the process chamber 3. Actually, however, the secondary pressure P1 of the first shut-off valve 15 and the secondary pressure P2 of the second shut-off valve 17 are unlikely to become equal.

For instance, in the cases where a Cv value of the first shut-off valve 15 is larger than that of the second shut-off valve 17 and where the discharge line 5 has a larger passage diameter or a shorter passage length than the supply line 4, the process gas tends to flow in the discharge line 5 more than in the supply line 4. In this case, when the first shut-off valve 15 is closed and the second shut-off valve 17 is opened, the discharge line 5 is evacuated to a vacuum condition more easily than the supply line 4, increasing the degree of vacuum in the discharge line 5 higher than in the supply line 4. In another case where a discharge time of the process gas to the discharge line 5 is shorter than a supply time to the process chamber 3, the degree of vacuum in the discharge line 5 becomes higher than that in the supply line 4. The above factors increase the secondary pressure P1 of the first shut-off valve 15 than the secondary pressure P2 of the second shut-off valve 17.

In this state, the secondary pressure P1 of the first shut-off valve 15 is higher than the primary pressure thereof. Accordingly, when the first shut-off valve 15 is changed from closed to open and simultaneously the second shut-off valve 17 is changed from open to closed, the process gas is liable to flow back from the first shut-off valve 15 to the MFC 14. Thus, the secondary pressure of the MFC 14 increases, decreasing an operating differential pressure of the MFC 14, thus resulting in a decrease in flow rate of the MFC 14. As a result, the cumulative flow rate of process gas supplied to the process chamber 3 is decreased. This decrease could be observed as the pressure of the process chamber 3 decreasing by X1 as shown in FIG. 9, for example.

To the contrary, in the cases where the Cv value of the first shut-off valve 15 is larger than that of the second shut-off valve 17 and where the supply line 4 has a larger passage diameter or a shorter passage length than the discharge line 5, the process gas tends to flow in the supply line 4 more than in the discharge line 5. In this case, when the first shut-off valve 15 is closed and the second shut-off valve 17 is opened, the supply line 4 is evacuated to a vacuum condition more easily than the discharge line 5, increasing the degree of vacuum in the process chamber 3 higher than in the discharge line 5. In another case where the gas supply time of the process gas to the process chamber 3 is shorter than the discharge time to the discharge line 5, the degree of vacuum in the supply line 4 becomes higher than that in the discharge line 5. The above factors decrease the secondary pressure P1 of the first shut-off valve 15 than the secondary pressure P2 of the second shut-off valve 17.

In this state, the secondary pressure P1 of the first shut-off valve 15 is lower than the primary pressure thereof. Accordingly, when the first shut-off valve 15 is changed from closed to open and simultaneously the second shut-off valve 17 is changed from open to closed, the process gas is liable to flow at high flow rate from the MFC 14 to the first shut-off valve 15. Thus, the secondary pressure of the MFC 14 decreases, increasing an operating differential pressure of the MFC 14, thus resulting in an increase in flow rate of the MFC 14. As a result, the cumulative flow rate of process gas supplied to the process chamber 3 is increased. This increase could be observed as the pressure of the process chamber 3 increasing by X2 as shown in FIG. 12, for example.

Consequently, the cumulative flow rate varies depending on combinations of various factors such as individual difference and age deterioration of the first shut-off valve 15, second shut-off valve 17, pipes, and MFC 14 and respective control states of the first and second shut-off valves 15 and 17. The variation in cumulative flow rate is likely to cause instability of the amount of process gas to be supplied to the process chamber 3, leading to an undesirable result that the film quality varies.

The present invention has been made to overcome the above problems and has an object to provide a gas supply unit capable of stabilizing a supply amount of gas.

To achieve the purpose of the invention, there is provided a gas supply unit including: a mass flow controller; a first fluid control valve connected to the mass flow controller; a second fluid control valve connected to the mass flow controller and arranged in parallel to the first fluid control valve; and a third fluid control valve place on a secondary side of the second fluid control valve, wherein an opening degree of the third fluid control valve is adjustable based on a pressure difference between secondary pressure of the first fluid control valve and secondary pressure of the second fluid control valve.

### BRIEF DESCRIPTION OF THE DRAWINGS

FIG. 1 is a circuit diagram of a gas supply unit of a first embodiment according to the present invention;

FIG. 2 is a plan view of the gas supply unit with a concrete example of a circuit shown in FIG. 1;

FIG. 3 is a side view of the gas supply unit viewed in a direction A in FIG. 2, in which a thick line indicates the flow of process gas;

FIG. 4 is another side view of the gas supply unit viewed in a direction B in FIG. 2, in which a thick line indicates the flow of process gas;

FIG. 5 is a graph showing a test result of a flow rate measuring test to determine a relationship between opening and closing actions of a first shut-off valve and a flow rate of a mass flow controller in the case where secondary pressure of the first shut-off valve is equal to secondary pressure of a second shut-off valve;

FIG. 6 is a graph showing a test result of an output pressure checking test to determine a relationship between opening and closing actions of the first shut-off valve and a second shut-off valve and pressure of a process chamber in the case where the secondary pressure of the first shut-off valve is equal to the secondary pressure of a second shut-off valve;

FIG. 7 is a graph showing a test result of a flow rate measuring test to determine a relationship between the opening and closing actions of the first shut-off valve and the flow rate of the MFC in the case where the secondary pressure of the first shut-off valve is higher than that of the second shut-off valve;

FIG. 8 is a graph showing a test result of an output pressure checking test to determine a relationship between the opening and closing actions of the first shut-off valve and the second shut-off valve and the pressure of the process chamber in the case where the secondary pressure of the first shut-off valve is higher than that of the second shut-off valve;

FIG. 9 is a graph showing comparison between the pressure variation in the process chamber in the flow rate checking process shown in FIG. 8 and the pressure variation in the process chamber in the case where the secondary pressures of the first and second shut-off valves are equal to each other;

FIG. 10 is a graph showing a test result of a flow rate measuring test to determine a relationship between the opening and closing actions of the first shut-off valve and the flow rate of the MFC in the case where the secondary pressure of the first shut-off valve is lower than that of the second shut-off valve;

FIG. 11 is a graph showing a test result of an output pressure checking test to determine a relationship between the opening and closing actions of the first shut-off valve and the second shut-off valve and the pressure of the process chamber in the case where the secondary pressure of the first shut-off valve is lower than that of the second shut-off valve;

FIG. 12 is comparison between the pressure variation in the process chamber in the flow rate checking process shown in FIG. 11 and the pressure variation in the process chamber in the case where the secondary pressures of the first and second shut-off valves are equal to each other;

FIG. 13 is a circuit diagram of a gas supply unit of a second embodiment according to the present invention;

FIG. 14 is a side view of the gas supply unit embodying a circuit shown in FIG. 13;

FIG. 15 is a circuit diagram of a gas supply unit of a third embodiment according to the present invention;

FIG. 16 is a circuit diagram of a gas supply unit of a forth embodiment according to the present invention; and

FIG. 17 is a circuit diagram of a conventional gas supply unit.

### DETAILED DESCRIPTION OF THE PREFERRED EMBODIMENTS

A detailed description of a preferred embodiment of the present invention will now be given referring to the accompanying drawings.

### First Embodiment

<Circuit Configuration>

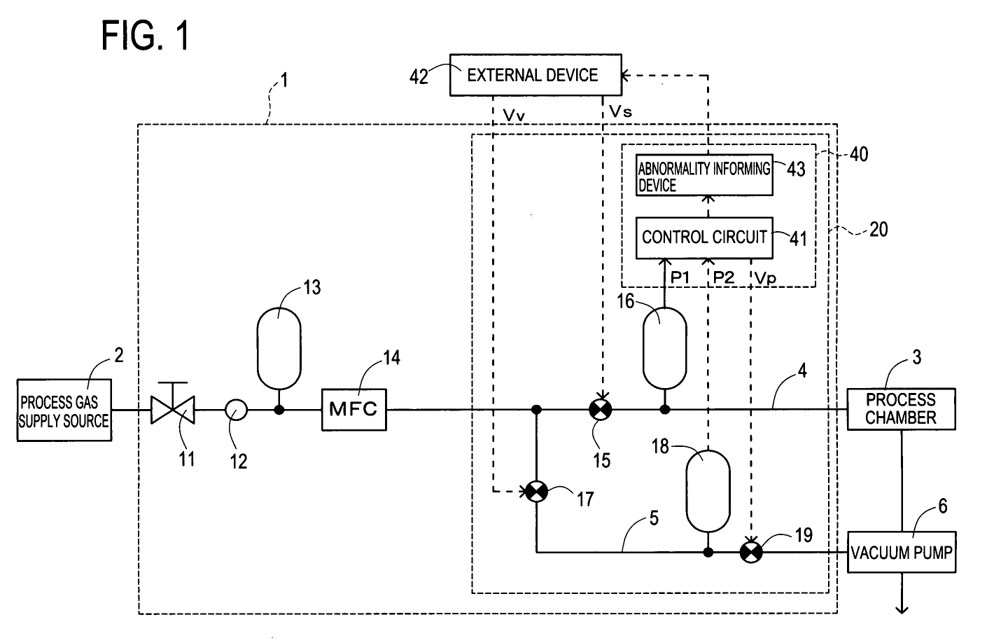

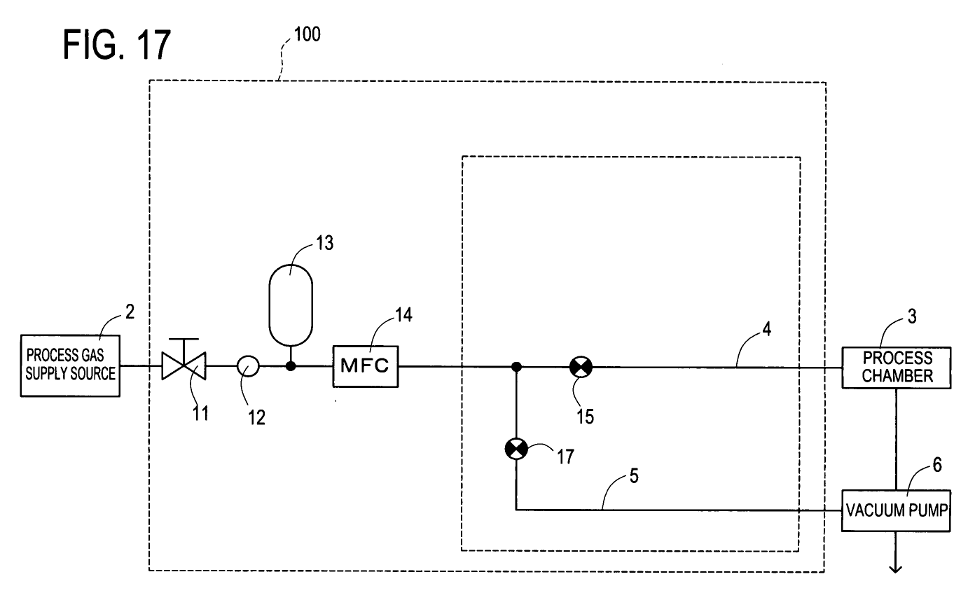

FIG. 1 is a circuit diagram of a gas supply unit 1 of the first embodiment. This gas supply unit 1 is basically identical in structure to the conventional gas supply unit 100 shown in FIG. 17. Thus, the gas supply unit 1 shown in FIG. 1 is given the same reference signs as those of the conventional gas supply unit 100. The gas supply unit 1 of the first embodiment will be installed in for example a CVD device as with the conventional gas supply unit 100. The gas supply unit 1 includes a supply line 4 and a discharge line 5. The supply line 4 connects between a process gas supply source 2 and a process chamber 3 which are placed outside the unit 1. The discharge line 5 branches from the supply line 4 and is connected to a vacuum pump 6. This vacuum pump 6 is also connected to the process chamber 3.

In the supply line 4, there are arranged, from an upstream side, a hand valve 11, a regulator 12, a pressure gauge 13, a mass flow controller (MFC) 14, a first shut-off valve 15 serving as an example of a “first fluid control valve”, and a pressure gauge 16 serving as an example of a “pressure difference measuring means”.

In the discharge line 5, there are arranged, from an upstream side, a second shut-off valve 17 serving as an example of a “second fluid control valve”, a pressure gauge 18 serving as an example of the “pressure difference measuring means”, and a pressure control valve 19 serving as an example of a “third fluid control valve”.

In the gas supply unit 1, the first and second shut-off valves 15 and 17, the pressure gauges 16 and 18, the pressure control valve 19 and a control unit 40 constitute a pressure control device 20. This pressure control device 20 is arranged to output an actuating signal Vp to the pressure control valve 19 to equalize secondary pressure P1 of the first shut-off valve 15 and secondary pressure P2 of the second shut-off valve 17. However, the “equal pressure” referred herein includes not only the exact same pressure but also the pressure with a difference of less than ±20 kPa (the grounds for this numeral will be mentioned later). The first and second shut-off valves 15 and 17 are controlled to open and close in response to actuating signals Vs and Vv transmitted from an external device 42.

<Concrete Configuration>

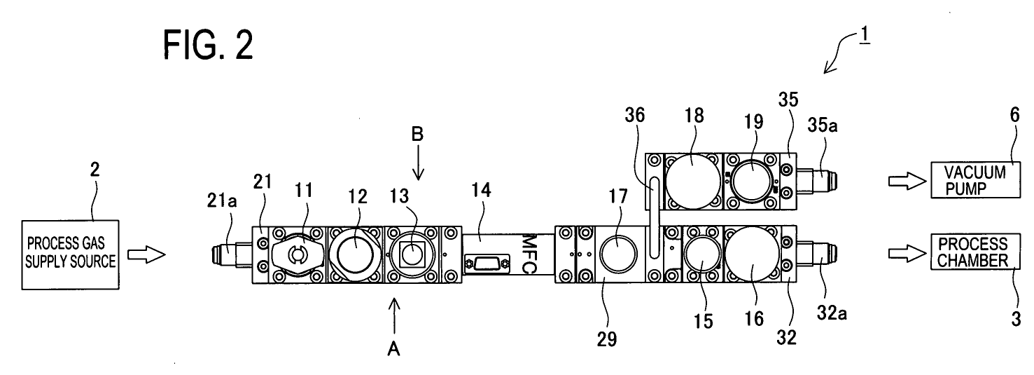

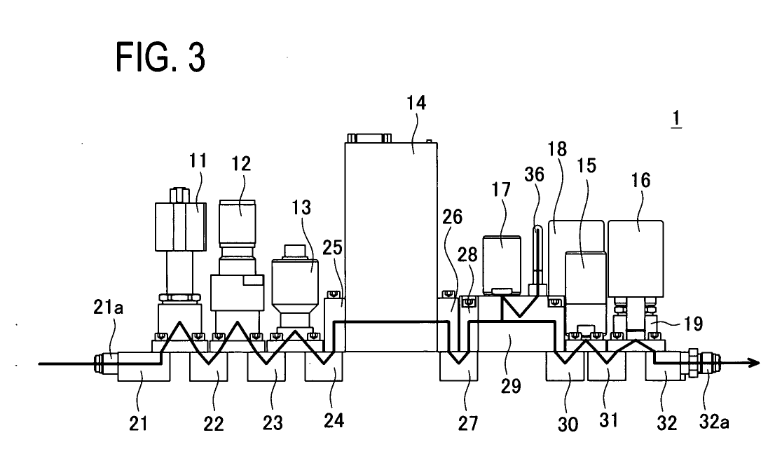

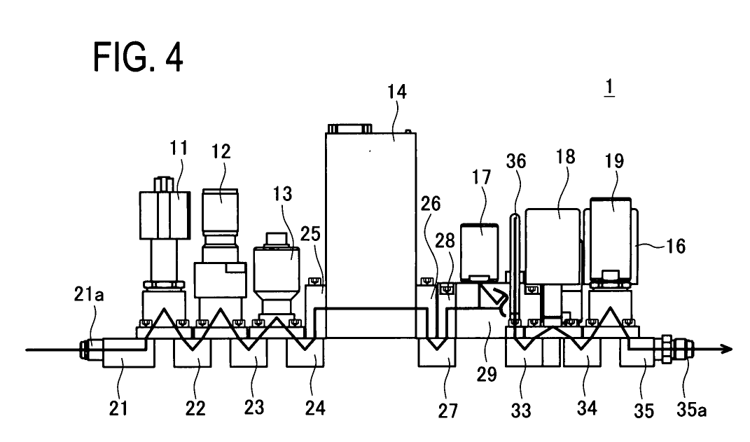

FIG. 2 is a plan view of the gas supply unit 1. FIG. 3 is a side view of the gas supply unit 1 viewed in a direction A in FIG. 2. FIG. 4 is another side view of the gas supply unit 1 viewed in a direction B in FIG. 2. In FIGS. 3 and 4, a thick line indicates the flow of process gas.

As shown in FIGS. 2 and 3, the gas supply unit 1 is composed of the hand valve 11, regulator 12, pressure gauge 13, MFC 14, second shut-off valve 17, first shut-off valve 15, and pressure gauge 16 which are fixed on upper surfaces of passage blocks 21 to 32 with bolts from above so that they are integrally connected to one another in line.

The second shut-off valve 17 is connected to the mass flow controller 14 so as to be arranged in parallel to the first shut-off valve 15.

The hand valve 11 has an inlet port that is communicated to an inlet part 21a of the passage block 21. The inlet part 21a is connected to the process gas supply source 2. Thus, the flow of the process gas supplied from the process gas supply source 2 to the inlet part 21a is allowed or shut off by the hand valve 11. An outlet port of the hand valve 11 is connected to an inlet port of the regulator 12 via the passage block 22. An outlet port of the regulator 12 is connected to an inlet port of the pressure gauge 13 via the passage block 23. The pressure of fluid controlled by the regulator 12 is measured by the pressure gauge 13. An outlet port of the pressure gauge 13 is connected to an inlet port of the MFC 14 via the passage blocks 24 and 25.

An outlet port of the MFC 14 is connected to an inlet port of the first shut-off valve 15 via the passage blocks 26 to 30, thereby allowing supply of process gas at a controlled flow rate. An outlet port of the first shut-off valve 15 is connected to an inlet port of the pressure gauge 16 via the passage block 31. Secondary pressure P1 of the first shut-off valve 15 is measured by the pressure gauge 16. An outlet port of the pressure gauge 16 is communicated to an outlet part 32a of the passage block 32. This outlet part 32a is also connected to the process chamber 3.

On the upper surface of the passage block 29, the second shut-off valve 17 and a bypass block 36 are fixed with bolts from above. The passage block 29 is formed with a branch passage branched from a main passage providing communication between the MFC 14 and the first shut-off valve 15, the branch passage being open in the upper surface of the block 29 and connected to an inlet port of the second shut-off valve 17. The passage block 29 is also formed with a V-shaped passage having two ports opening in the above surface to provide communication between an outlet port of the second shut-off valve 17 and the bypass block 36.

As shown in FIGS. 2 and 4, the pressure gauge 18 and the pressure control valve 19 are fixed on the passage blocks 33 to 35 with bolts from above so that they are integrally connected to each other in line. On the upper surface of the passage block 33, the bypass block 36 is also fixed with bolts from above. The pressure gauge 18 has an inlet port connected to an outlet port of the second shut-off valve 17 via the passage block 33, bypass block 36, and passage block 29 and serves to measure the secondary pressure P2 of the second shut-off valve 17.

An outlet port of the pressure gauge 18 is connected to an inlet port of the pressure control valve 19 via the passage block 34. The pressure control valve 19 has an outlet port connected to a discharge part 35a of the passage block 35 and serves to control the pressure of process gas that flows therein from the pressure gauge 18 and output the controlled process gas to the discharge part 35a. The discharge part 35a is connected to the vacuum pump 6.

<Control Device>

As shown in FIG. 1, the control device 40 includes a control circuit 41 and an abnormality informing device 43. The control circuit 41 is connected to the pressure gauges 16 and 18 and the pressure control valve 19, separately. The control circuit 41 receives the signals representing the secondary pressures P1 and P2 of the first and second shut-off valves 15 and 17 from the pressure gauges 16 and 18 respectively to calculate a pressure difference, and outputs a pressure control signal Vp based on the calculated pressure difference to the pressure control valve 19.

On the other hand, the abnormality informing device 43 is connected to the control circuit 41. When any abnormality is detected in the pressures P1 and P2 measured by the pressure gauges 16 and 18 (for instance, the pressures P1 and P2 exceed upper limits or the pressure difference between the pressures P1 and P2 is larger than a predetermined value), this informing device 43 gives a warning to inform the abnormality for example by sounding an alarm or lighting a warning lamp. At the same time when informs the abnormality, the informing device 43 outputs an abnormality signal to the external device 42.

In the present embodiment, the pressure control device 20 containing the control unit 40 is incorporated in the gas supply unit 1. Alternatively, the control unit 40 may be externally attached to the gas supply unit 1. For instance, the control unit 40 may be provided in a higher-level device such as a control section of a semiconductor control device. In this case, the higher-level device is connected to the pressure gauges 16 and 18 and the pressure control valve 19 by wiring for allowing communication.

<Operations>

The following explanation is given to operations of the gas supply unit 1.

During non-process, the gas supply unit 1 is operated to open the hand valve 11, second shut-off valve 17, and pressure control valve 19 and close the first shut-off valve 15. Accordingly, the process gas supplied from the process gas supply source 2 to the inlet part 21a is allowed to pass through the hand valve 11, regulator 12, pressure gauge 13, MFC 14, second shut-off valve 17, pressure gauge 18, and pressure control valve 19. The process gas is then discharged through the discharge part 35a to the vacuum pump 6.

At this time, the control circuit 41 receives the signals representing the secondary pressures P1 and P2 of the first and second shut-off valves 15 and 17 from the pressure gauges 16 and 18 respectively. The control circuit 41 constantly measures a pressure difference between the secondary pressures P1 and P2 to output the pressure control signal Vp to the pressure control valve 19 to equalize the secondary pressure P1 and P2 (in the present embodiment, with a pressure difference of less than ±20 kPa).

Specifically, when the secondary pressure P1 of the first shut-off valve 15 is higher than the secondary pressure P2 of the second shut-off valve 17, the control circuit 41 outputs a pressure control signal Vp for decreasing the opening degree of the pressure control valve 19. By decreasing conductance to decrease the opening degree of the pressure control valve 19, the amount of process gas to be discharged is decreased and the secondary pressure P2 of the second shut-off valve 17 is increased.

Further, when the secondary pressure P1 of the first shut-off valve 15 is lower than the secondary pressure P2 of the second shut-off valve 17, the control circuit 41 outputs a pressure control signal Vp for increasing the opening degree of the pressure control valve 19. By increasing conductance to increase the opening degree of the pressure control valve 19, the amount of process gas to be discharged is increased and the secondary pressure P2 of the second shut-off valve 17 is decreased.

As described above, after the secondary pressures P1 and P2 of the first and second shut-off valves 15 and 17 are controlled to become equal (with a pressure difference of less than ±20 kPa in the present embodiment), the gas supply unit 1 is operated to supply process gas to the process chamber 3 with the first and second shut-off valves 15 and 17 controlled by the external device 42.

<Influences and Effects>

The following explanation will be given to influences and effects of the gas supply unit 1 of the present embodiment.

The inventors checked how the secondary pressures P1 and P2 of the first and second shut-off valves 15 and 17 have an influence on the internal pressure P3 of the process chamber 3 and on the MFC 14.

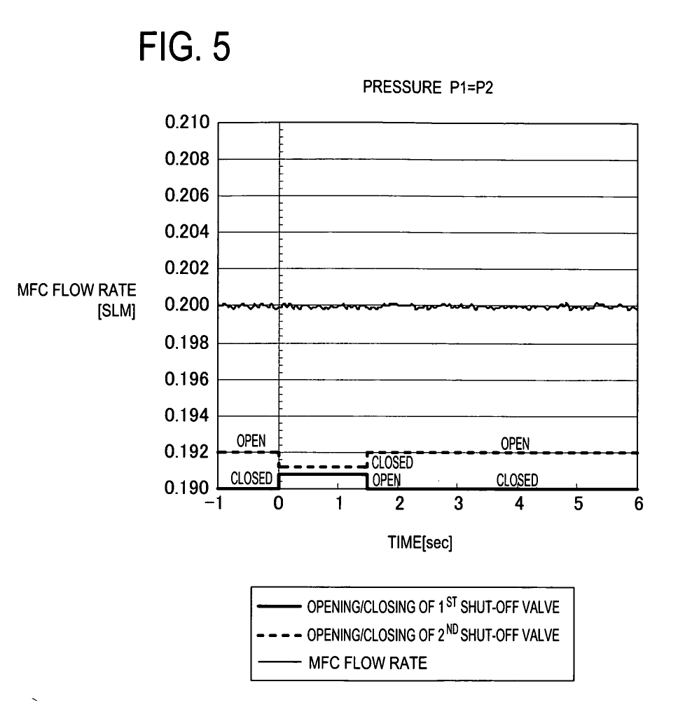

FIGS. 5, 7, and 10 are graphs showing test results of a flow rate measuring test to determine a relationship between opening and closing actions of the first shut-off valve 15 and the flow rate of the MFC 14. In each graph, a vertical axis indicates the flow rate of the MFC 14 (SLM) and a horizontal axis indicates time (sec). In FIGS. 5, 7, and 10, the opened and closed states of the first and second shut-off valves 15 and 17 are plotted together in order to exhibit the relationship between the MFC flow rate and the opening and closing actions of each of first and second shut-off valves 15 and 17.

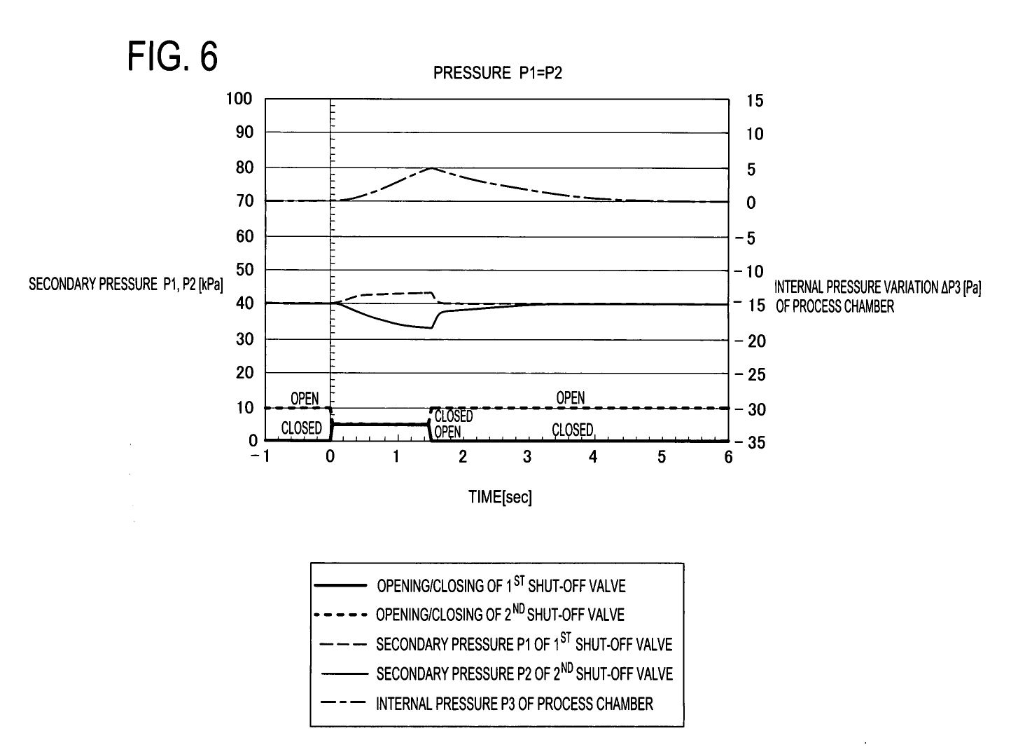

FIGS. 6, 8, and 11 are graphs showing test results of an output pressure checking test to determine a relationship between the opening and closing actions of the first and second shut-off valves 15 and 17 and the internal pressure P3 of the process chamber 3. In each graph, a vertical axis indicates line pressures P1 and P2 and a variation (fluctuation) ΔP3 (Pa) in internal pressure of the process chamber 3 and a horizontal axis indicates time (sec). In FIGS. 6, 8, and 11, the opened and closed states of the first and second shut-off valves 15 and 17 are plotted together in order to exhibit the relationship of the secondary pressures of the first and second shut-off valves 15 and 17 and the internal-pressure variation in the process chamber 3 with respect to the opening and closing actions of the first and second shut-off valves 15 and 17.

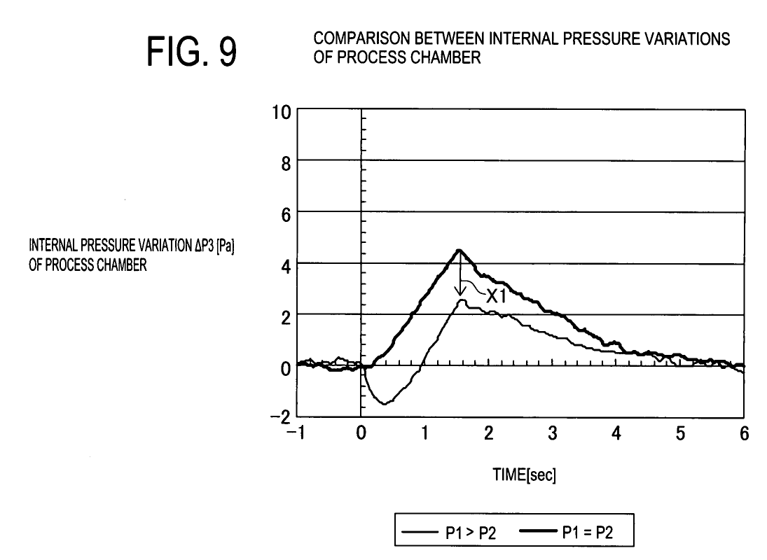

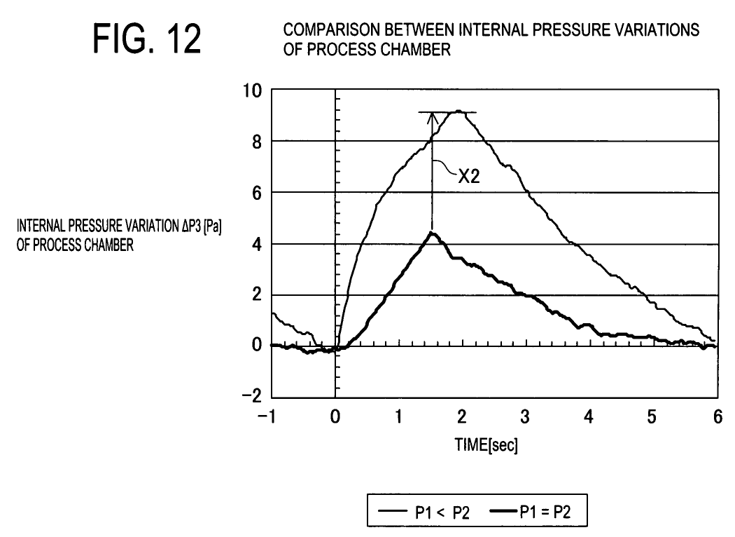

FIGS. 9 and 12 are graphs totally showing how the pressure P3 of the process chamber 3 is different between the case where the secondary pressure P1 of the first shut-off valve 15 and the secondary pressure P2 of the second shut-off valve 17 are controlled to be different and the case where the secondary pressures P1 and P2 are controlled to be equal.

As shown in FIG. 5, after the secondary pressure P1 of the first shut-off valve 15 and the secondary pressure P2 of the second shut-off valve 17 are equalized, the first shut-off valve 15 is changed from a closed state to an open state and simultaneously the second shut-off valve 17 is changed from an open state to a closed state. At this time, the secondary pressure of the MFC 14 remains unchanged at a constant level, thereby providing a stable flow rate of process gas to be supplied to the process chamber 3.

As shown in FIG. 6, therefore, the pressure P3 of the process chamber 3 gently increases from the start of opening to the start of closing of the first shut-off valve 15 and subsequently changes linearly.

In the case where, after the secondary pressures P1 and P2 of the first and second shut-off valves 15 and 17 are made equal, the first shut-off valve 15 is changed from closed to open and the second shut-off valve 17 is changed from open to closed, the flow rate of the MFC 14 is constant irrespective of individual differences of the MFC 14, the first and second shut-off valves 15 and 17, and others. Thus, the flow rate of process gas to be supplied to the process chamber 3 can be stabilized.

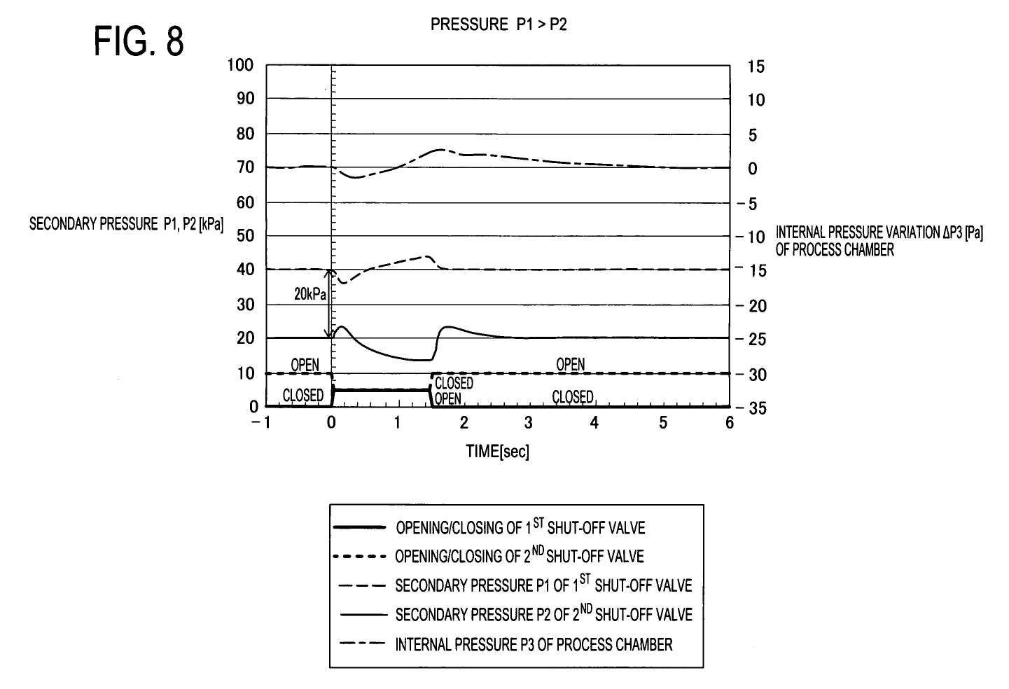

On the other hand, while the secondary pressure P1 of the first shut-off valve 15 is higher than the secondary pressure P2 of the second shut-off valve 17 by 20 kPa, as shown in FIG. 8, when the first shut-off valve 15 is changed from closed to open and the second shut-off valve 17 is changed from open to closed, the pressure P3 of the process chamber 3 decreases at the moment when the first shut-off valve 15 is changed to the open state, and subsequently the pressure P3 increases until the first shut-off valve 15 is changed to the closed state. This seems to be caused by the back-flow phenomenon that the process gas flows back from the process chamber 3 to the gas supply unit 1 at the moment of opening the first shut-off valve 15 and closing the second shut-off valve 17 because the primary pressure of the first shut-off valve 15 is lower than the secondary pressure thereof.

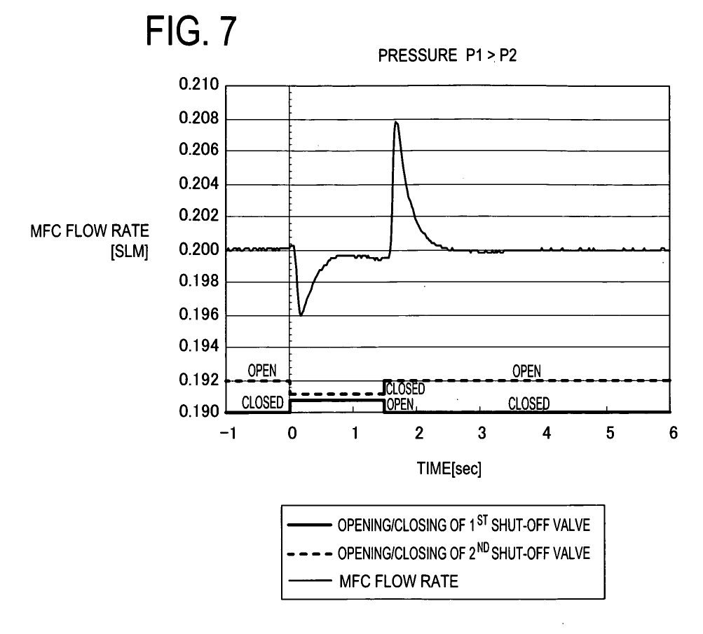

Accordingly, when the first shut-off valve 15 is changed from closed to open and the second shut-off valve 17 is changed from open to closed while the secondary pressure P1 of the first shut-off valve 15 is higher than the secondary pressure P2 of the second shut-off valve 17 by 20 kPa, as shown in FIG. 7, the flow rate of the MFC 14 decreases at the moment of opening the first shut-off valve 15 from the closed state and closing the second shut-off valve 17 from the opened state, and subsequently, the flow rate is regulated to a set flow rate. This is because, the secondary pressure of the MFC 14 increases due to the back-flow phenomenon caused at the moment when the first shut-off valve 15 is changed from closed to open and the second shut-off valve 17 is changed from open to closed and an operating differential pressure of the MFC 14 decreases.

As for the pressure P3 of the process chamber 3, as shown in FIG. 9, comparison is made between the case where the secondary pressure P1 of the first shut-off valve 15 and the secondary pressure P2 of the second shut-off valve 17 are equal (indicated by the thick line in the graph) and the case where the secondary pressure P1 is higher by 20 kPa than the secondary pressure P2 (indicated by the thin line in the graph). As shown by X1 in the graph, the pressure P3 of the process chamber 3 in the case where the secondary pressure P1 is higher by 20 kPa than the secondary pressure P2 (the thin line in the graph) is entirely lower than the pressure P3 of the case where the secondary pressures P1 and P2 are equal (the thick line in the graph).

The above test results show that when the first shut-off valve 15 is changed from closed to open and the second shut-off valve 17 is changed from open to closed while the secondary pressure P1 of the first shut-off valve 15 is higher by 20 kPa than the secondary pressure P2 of the second shut-off valve 17, the gas flows back from the process chamber 3 to the MFC 14 at the instant when the first shut-off valve 15 is opened, increasing the secondary pressure of the MFC 14, thus decreasing the operating differential pressure of the MFC 14, so that the flow rate of the MFC 14 varies temporarily. Accordingly, it is found that the increasing rate of the pressure P3 of the process chamber 3 is entirely lower than in the case where the first shut-off valve 15 is changed from closed to open after the secondary pressures P1 and P2 are made equal, so that the cumulative flow rate of process gas to the process chamber 3 is insufficient.

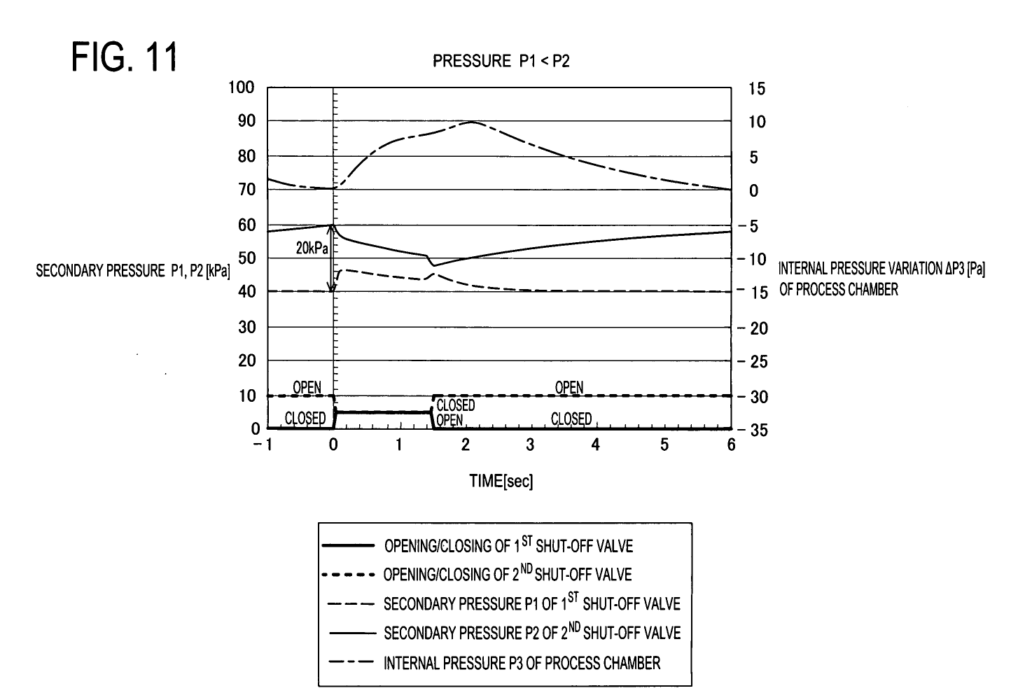

On the other hand, when the first shut-off valve 15 is changed from closed to open and the second shut-off valve 17 is changed from open to closed while the secondary pressure P1 of the first shut-off valve 15 is lower by 20 kPa than the secondary pressure P2 of the second shut-off valve 17, as shown in FIG. 11, the pressure P3 of the process chamber 3 increases like a parabolic curve during a period from opening to closing of the first shut-off valve 15. This seems to be caused by an excess-flow phenomenon that a large amount of process gas is caused to flow in the process chamber 3 at the moment when the first shut-off valve 15 is opened and the second shut-off valve 17 is closed because the primary pressure of the first shut-off valve 15 is higher than the secondary pressure thereof.

Accordingly, when the first shut-off valve 15 is changed from closed to open and the second shut-off valve 17 is changed from open to closed while the secondary pressure P1 of the first shut-off valve 15 is lower by 20 kPa than the secondary pressure P2 of the second shut-off valve 17, the flow rate of the MFC 14 becomes higher than the set flow rate at the moment when the first shut-off valve 15 is changed from closed to open and the second shut-off valve 17 is changed from open to closed, and subsequently, the flow rate is regulated to the set flow rate. This seems to result from the excess-flow phenomenon caused as soon as the first shut-off valve 15 is changed from closed to open and the second shut-off valve 17 is changed from open to closed, decreasing the secondary pressure of the MFC 14, thus increasing the operating differential pressure of the MFC 14. Accordingly, at the time when the first shut-off valve 15 is opened, the process gas is caused to flow at a flow rate higher than the set flow rate to the process chamber 3.

As for the pressure P3 of the process chamber 3, as shown in FIG. 12, comparison is made between the case where the secondary pressure P1 of the first shut-off valve 15 and the secondary pressure P2 of the second shut-off valve 17 are equal (indicated by the thick line in the graph) and the case where the secondary pressure P1 is lower by 20 kPa than the secondary pressure P2 (indicated by the thin line in the graph). As shown by X2 in the graph, the pressure P3 of the process chamber 3 in the case where the secondary pressure P1 is lower by 20 kPa than the secondary pressure P2 (the thin line in the graph) is entirely higher than the pressure P3 of the case where the secondary pressures P1 and P2 are equal (the thick line in the graph).

The above test results show that when the first shut-off valve 15 changed from closed to open and the second shut-off valve 17 is changed from open to close while the secondary pressure P1 of the first shut-off valve 15 is lower by 20 kPa than the secondary pressure P2 of the second shut-off valve 17, a large amount of the process gas flows from the first shut-off valve 15 to the process chamber 3 because the primary pressure is higher than the secondary pressure of the first shut-off valve 15 at the moment when this valve 15 is opened, thus decreasing the secondary pressure of the MFC 14. Accordingly, the operating differential pressure of the MFC 14 is increased and the flow rate varies temporarily. It is found that the increasing rate of the pressure P3 of the process chamber 3 is entirely higher than in the case where the first shut-off valve 15 is changed from closed to open and the second shut-off valve 17 is changed from open to closed while the secondary pressures P1 and P2 are equal, so that the cumulative flow rate of process gas to the process chamber 3 is excessive.

Consequently, the gas supply unit 1 of the first embodiment is arranged to measure the secondary pressure P1 of the first shut-off valve 15 and the secondary pressure P2 of the second shut-off valve 17 by the pressure gauges 16 and 18 respectively, adjust the opening degree (conductance) of the pressure control valve 19 to equalize the secondary pressures P1 and P2, and then change the first shut-off valve 15 from closed to open. Here, the “equal pressure” is preferably defined by a pressure difference of less than ±20 kPa between the secondary pressures P1 and P2. If the pressure difference between the secondary pressures P1 and P2 is 20 kPa or more as shown in FIGS. 8 and 11, the pressure P3 of the process chamber 3 tends to largely deviate from that in the case where the secondary pressures P1 and P2 are equal as shown in FIGS. 9 and 12, resulting in a variation in cumulative flow rate. By adjusting the opening degree of the pressure control valve 19 based on the pressure difference between the secondary pressures P1 and P2 as above, the secondary pressure of the MFC 14 can be constantly maintained at a constant level irrespective of the opening/closing actions of the first and second shut-off valves 15 and 17. Accordingly, the gas supply unit 1 of the present embodiment can prevent the aforementioned disadvantages such the back-flow of the process gas from the process chamber 3 to the MFC 14 leading to an extreme decrease in the cumulative flow rate and the flow of a large amount of process gas from the MFC 14 to the first shut-off valve 15 leading to an extreme increase in cumulative flow rate. Thus, the amount of process gas to be supplied to the process chamber 3 can be stabilized.

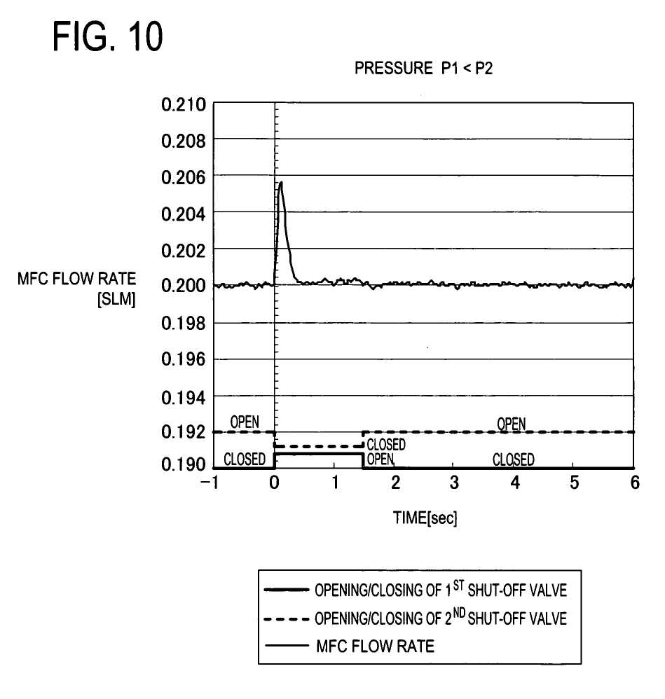

In particular, as shown in FIGS. 7 and 10, when the first shut-off valve 15 is changed from closed to open and the second shut-off valve 17 is changed from open to closed while the secondary pressures P1 and P2 of the first and second shut-off valves 15 and 17 are not equal (with a pressure difference of less than ±20 kPa), the secondary pressure of the MFC 14 rapidly varies, causing a change in operating differential pressure of the MFC 14. This causes an unstable flow rate. In this case, it takes several hundred seconds to stabilize the flow rate. Accordingly, as a cycle time for changing the first and second shut-off valves 15 and 17 from open to closed or vice versa is shorter, it has a larger influence on the cumulative flow rate. Thus, a larger advantage can be provided by control to equalize the secondary pressures P1 and P2 (with a pressure difference of less than ±20 kPa) and then open the first shut-off valve 15.

In addition, the MFC 14, first and second shut-off valves 15 and 17, and other devices or components have individual differences and are liable to cause age deterioration. Therefore, it is difficult to equalize the secondary pressures P1 and P2 of the first and second shut-off valves 15 and 17. However, the pressure control valve 19 serves to control the pressure difference between the pressures P1 and P2 so as to be less than ±20 kPa. Accordingly, even where the MFC 14, first and second shut-off valves 15 and 17, and others have individual differences and cause age deterioration, the supply amount of process gas can be stabilized.

Stabilization of the cumulative flow rate of the gas supply unit 1 can achieve a fixed film-deposition condition. Thus, the semiconductor manufacturing device incorporating the gas supply unit 1 of the first embodiment can provide improved film-deposition quality.

Further, the gas supply unit 1 of the first embodiment is arranged to measure the secondary pressure P1 of the first shut-off valve 15 by the pressure sensor 16 and the secondary pressure P2 of the second shut-off valve 17 by the pressure sensor 18, and calculate a pressure difference between the measured secondary pressures P1 and P2 to adjust the opening degree of the pressure control valve 19. Accordingly, the secondary pressure P2 of the second shut-off valve 17 can be regulated to be equal to the secondary pressure P1 of the first shut-off valve 15 with a pressure difference of less than ±20 kPa.

In case the secondary pressure P1 of the first shut-off valve 15 or the secondary pressure P2 of the second shut-off valve 17 is in an abnormal condition, the gas supply unit 1 of the first embodiment informs a user of the abnormality for example by sounding an alarm or lighting a warning lamp. Thus, the gas supply unit 1 of the first embodiment makes it possible to prevent the occurrence of unstable gas supply.

### Second Embodiment

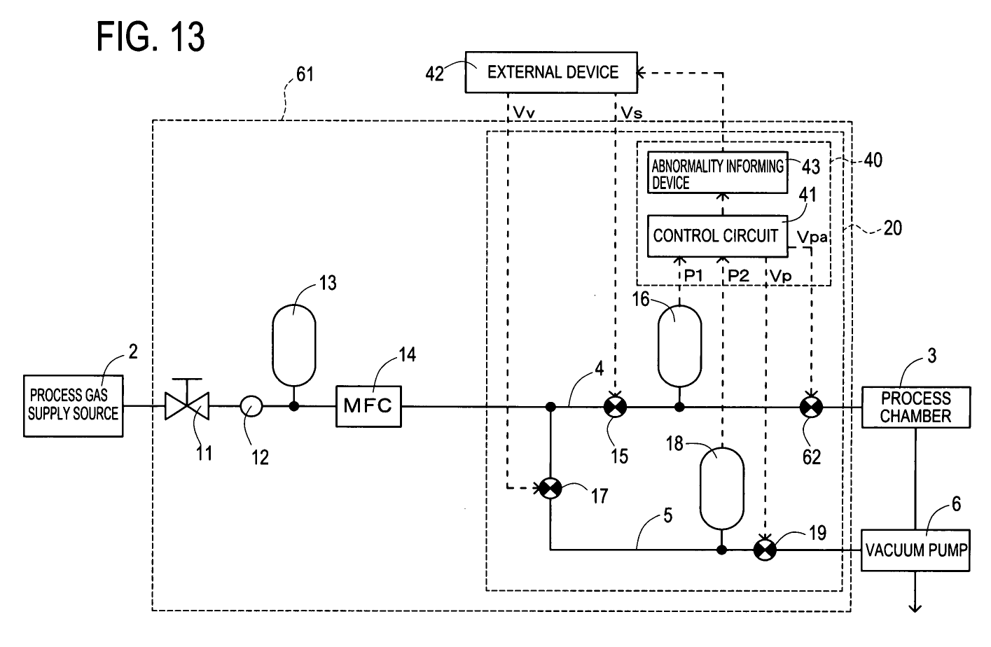

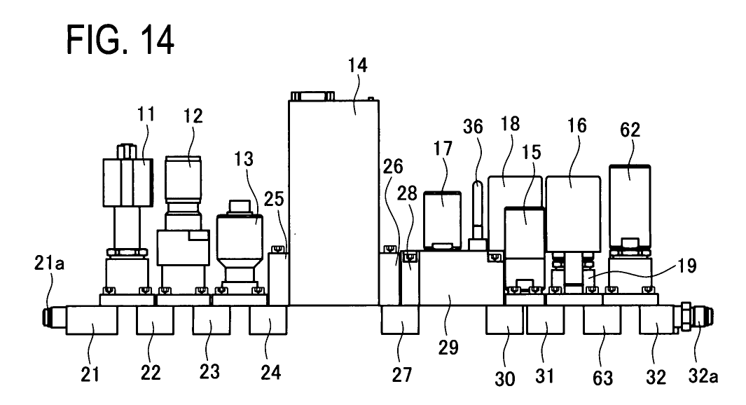

A second embodiment of the gas supply unit according to the present invention will be described below, referring to the accompanying drawings. FIG. 13 is a circuit diagram of a gas supply unit 61 of the second embodiment and FIG. 14 is a side view of the gas supply unit 61 embodying the circuit shown in FIG. 13.

The gas supply unit 61 of the second embodiment differs from the gas supply unit 1 of the first embodiment in that a pressure control valve 62 serving as an example of a “fourth fluid control valve” is placed on the secondary side of the pressure gauge 16. Herein, the explanation is made with a focus on the differences from the first embodiment and common or similar configurations are given the same reference signs as those in the first embodiment to omit their detailed description.

As shown in FIG. 14, the pressure control valve 62 has an inlet port connected to the outlet port of the pressure gauge 16 via a passage block 63 and an outlet port connected to the output part 32a of the passage block 32. As shown in FIG. 13, in the control device 40, the control circuit 41 is connected to the pressure control valve 62 and outputs a pressure control signal Vpa to the pressure control valve 62.

The gas supply unit 61 of the second embodiment is arranged to output the pressure control signals Vp and Vpa based on the secondary pressures P1 and P2 of the first and second shut-off valves 15 and 17 measured by the pressure gauges 16 and 18 to the pressure control valves 19 and 62 respectively, thereby adjusting the opening degrees of the pressure control valves 19 and 62. The secondary pressures P1 and P2 of the first and second shut-off valves 15 and 17 are simultaneously controlled by the pressure control valves 19 and 62. This makes it possible to equalize the secondary pressures P1 and P2 (a pressure difference of less than ±20 kPa) in a short time.

### Third Embodiment

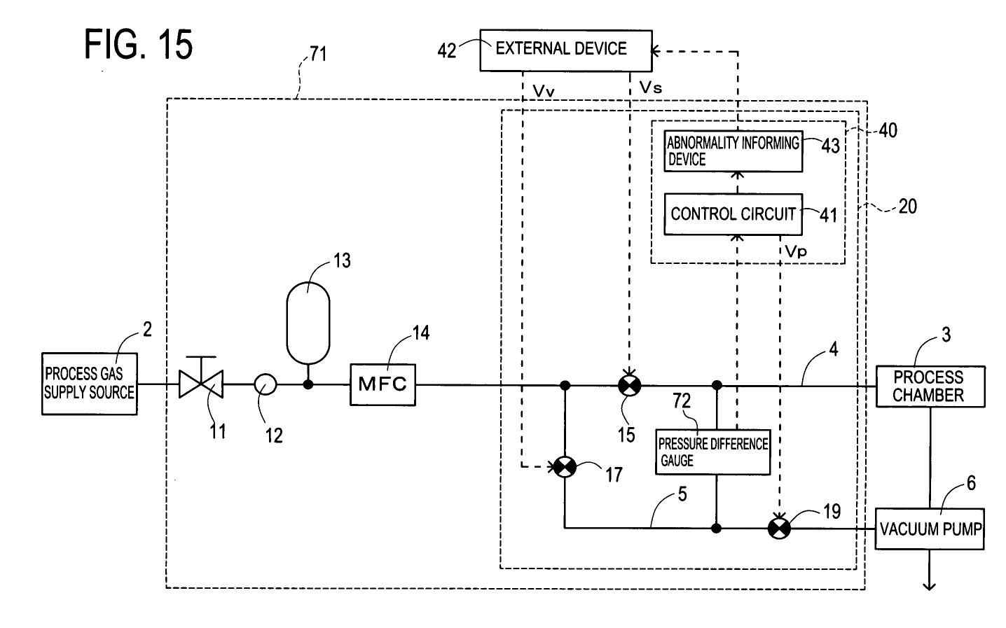

A third embodiment of the gas supply unit according to the present invention will be described below, referring to the accompanying drawings. FIG. 15 is a circuit diagram of a gas supply unit 71 of the third embodiment.

The gas supply unit 71 of the third embodiment differs from the gas supply unit 1 of the first embodiment in that a pressure difference gauge 72 serving as an example of a “pressure difference measuring means” is provided instead of the pressure gauges 16 and 18. Herein, the explanation is made with a focus on the differences from the first embodiment and common or similar configurations are given the same reference signs as those in the first embodiment to omit their detailed description.

In the gas supply unit 71, the pressure difference gauge 72 is connected to the secondary sides of the first and second shut-off valves 15 and 17 respectively. In the discharge line 5, the pressure control valve 19 is placed on the secondary side of the pressure difference gauge 72. In the control device 40, the control circuit 41 is connected to the pressure difference gauge 72 to receive a signal representing a pressure difference between the secondary pressures P1 and P2 of the first and second shut-off valves 15 and 17 and then output a pressure control signal Vp to the pressure control valve 19, thereby equalizing the secondary pressures P1 and P2 (with a pressure difference of less than ±20 kPa).

The gas supply unit 71 of the third embodiment using the pressure difference gauge 71 instead of the pressure gauges 16 and 18 can achieve a smaller foot space than the gas supply unit 1 of the first embodiment, leading to a cost reduction.

### Fourth Embodiment

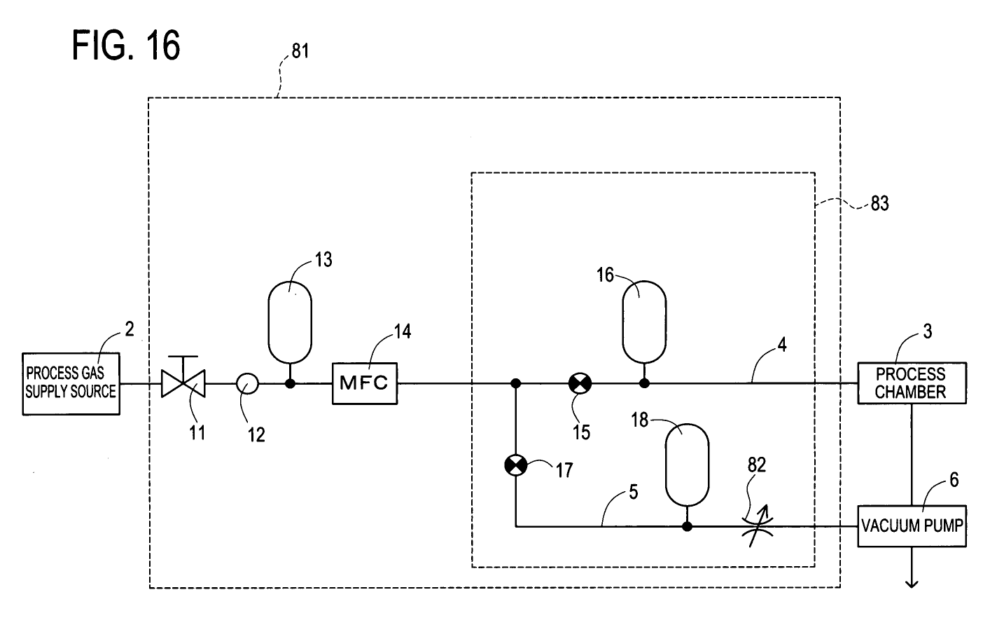

A fourth embodiment of the gas supply unit according to the present invention will be described below, referring to the accompanying drawings. FIG. 16 is a circuit diagram of a gas supply unit 81 of the fourth embodiment.

The gas supply unit 81 of the fourth embodiment differs from the gas supply unit 1 of the first embodiment in that a hand-operated flow control valve 82 serving as an example of a “third fluid control valve” is provided instead of the pressure control valve 19. Herein, the explanation is made with a focus on the differences from the first embodiment and common or similar configurations are given the same reference signs as those in the first embodiment to omit their detailed description.

In the gas supply unit 81, the hand-operated flow control valve 82, the opening degree of which is manually adjusted, is placed on the secondary side of the pressure gauge 18. A pressure control device 83 uses the hand-operated flow control valve 82 and therefore does not include the control device 40.

When the second shut-off valve 17 is changed to a closed state and the first shut-off valve 15 is changed to an open state, the opening degree of the hand-operated flow control valve 82 is adjusted to equalize the pressures measured by the pressure gauges 16 and 18 (with a pressure difference of less than ±20 kPa). This control may be performed for example in the case where the flow rate of the MFC 14 fluctuates as well as in the case of periodic maintenance.

The above gas supply unit 81 using the hand-operated flow control valve 82 does not require the control device 40. This unit 81 is thus a simpler configuration than the gas supply unit 1 of the first embodiment, leading to a cost reduction.

As an alternative, the gas supply unit 81 of the fourth embodiment may be arranged such that the pressure gauges 16 and 18 are eliminated and the opening degree of the hand-operated flow control valve 82 is adjusted so that the flow-rate reading of the MFC 14 is constant. From this constant flow rate reading of the MFC 14, it is confirmed that the pressure difference between the secondary pressures P1 and P2 of the first and second shut-off valves 15 and 17 is small.

The present invention may be embodied in other specific forms without departing from the spirit or essential characteristics thereof.

For instance, the above embodiments use the MFC 14 to measure a flow rate but may use a mass flow meter instead thereof.

In the second embodiment, the pressure control valve 62 is placed in the supply line 4. Alternatively, a hand-operated flow control valve may be placed instead of the pressure control valve 62.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A gas supply unit including:
a mass flow controller;
a first fluid control valve connected to the mass flow controller;
a second fluid control valve connected to the mass flow controller and arranged in parallel to the first fluid control valve; and
a third fluid control valve place on a secondary side of the second fluid control valve,
wherein an opening degree of the third fluid control valve is adjustable based on a pressure difference between secondary pressure of the first fluid control valve and secondary pressure of the second fluid control valve.

2. The gas supply unit according to claim 1 further including:
a pressure difference measuring device for measuring the pressure difference between the secondary pressure of the first fluid control valve and the secondary pressure of the second fluid control valve,
wherein the third fluid control valve is operated based on a measured result of the pressure difference measuring device.

3. The gas supply unit according to claim 1 further including a fourth fluid control valve placed on a secondary side of the first fluid control valve,
wherein the third fluid control valve and the fourth fluid control valve are operated to control the secondary pressure of the first control valve and the secondary pressure of the second fluid control valve respectively.

4. The gas supply unit according to claim 1 further including:
an abnormality informing device for informing abnormality when the abnormality occurs in one of the secondary pressure of the first fluid control valve and the secondary pressure of the second fluid control valve.

5. The gas supply unit according to claim 1, wherein
the pressure difference between the secondary pressure of the first fluid control valve and the secondary pressure of the second fluid control valve is controlled to be less than ±20 kPa.
wherein the third fluid control valve and the fourth fluid control valve are operated to control the secondary pressure of the first control valve and the secondary pressure of the second fluid control valve respectively.

4. The gas supply unit according to claim 1 further including:
an abnormality informing device for informing abnormality when the abnormality occurs in one of the secondary pressure of the first fluid control valve and the secondary pressure of the second fluid control valve.

5. The gas supply unit according to claim 1, wherein
the pressure difference between the secondary pressure of the first fluid control valve and the secondary pressure of the second fluid control valve is controlled to be less than ±20 kPa.
